(19) United States
(12) Patent Application Publication
(10) Pub. No.: US 2010/0278454 A1
(43) Pub. Date: Nov. 4, 2010

(54) TAMPER-EVIDENT LAMINATE STRUCTURE

(75) Inventor: Scott Huffer, Hartsville, SC (US)

Correspondence Address: FLASTER/GREENBERG P.C.;Four Penn Center, 1600 John F. Kennedy Boulevard, 2nd Floor, PHILADELPHIA, PA, 19103, US

(73) Assignee: Sonoco Development, Inc., Hartsville, SC (US)

(21) Appl. No.: 12/432,005

(22) Filed: Apr. 29, 2009

(51) Int. Cl. B65D 33/24; B32B 33/00; B65D 85/00; B65D 65/32

(52) U.S. Cl. 383/5; 428/41.8; 206/459.1; 383/203; 383/207

(57) ABSTRACT

A laminate material for a flexible packaging is provided having first and second layers. The first layer has a weakened line therethrough that defines a first flap. The second layer is adhered to the first layer and has a second weakened line formed offset from the first weakened line in the first layer and defines a removable panel in the second layer. An adhesive layer is located between the first and second layers. The adhesive layer comprises pressure-sensitive adhesive located inwardly of the weakened line in the first layer and a vacancy located laterally inward of the pressure-sensitive adhesive and adjacent the removable panel. The removable panel remains connected to the second layer when the first flap is peeled back. The removable panel is separately removable from the first flap. The first flap is resealable to the second layer by means of the pressure-sensitive adhesive exposed upon opening the first flap.

### TECHNICAL FIELD

The present disclosure relates to laminate materials for packaging. More specifically, the present disclosure relates to providing a reclosable, tamper-evident packaging material.

### BACKGROUND

A variety of food and non-food products are packaged using flexible packaging materials formed primarily of laminations of one or more of polymer films, metallized polymer films, paper, metal foil and the like. In many instances, packages contain products that may be used or consumed a portion at a time. Such products may be susceptible to being adversely affected (e.g., becoming stale, soggy, dry, etc.) by exposure to the surrounding environment. Accordingly, there is frequently a desire to be able to reclose a package after its initial opening to maintain the remaining product fresh.

US 2005/0276525 to Hebert et al. shows a package having laminate panels that use pressure-sensitive adhesive to facilitate reclosing of a flap.

With the introduction of reclosable packages, it is also desirable to provide an indication of prior opening of the package. By way of example, it may be possible to open such a package, remove a portion of the product contained therein and then reclose the package without actually purchasing the product. A subsequent purchaser will then obtain only a portion of the product for which the full purchase price is paid.

U.S. Pat. No. 7,344,744 to Sierra-Gomez et al. shows a package having an openable flap and a tamper-evident structure to indicate whether the product contained in the package has been accessed. The tamper-evident structure is in the form of strips or other structure that has been affixed to the flap. The strips must be removed prior to opening the flap or are broken as the flap is opened. The use of such extraneous materials to provide tamper-evidence may complicate the manufacturing process and result in the use of additional material to construct the package.

### SUMMARY

A laminate material for packaging is provided having first and second layers. The first layer includes a weakened line at least partially therethrough that defines a first flap. The second layer is adhered to the first layer and a second weakened line is formed therein, offset from the first weakened line, that defines a removable panel. An adhesive layer is located between the first and second layers. The adhesive layer comprises pressure-sensitive adhesive proximate the weakened line in the first layer. A vacancy is located inward of the pressure-sensitive adhesive and between the removable panel and the first layer. The removable panel remains connected to the second layer when the first flap is peeled back along the defining weakened line. The pressure-sensitive adhesive is exposed when the first flap is peeled back. The flap may be resealed to the second layer by returning it to its original position, in contact with the pressure-sensitive adhesive.

A further aspect of the invention provides a flexible packaging structure having built-in reclose and tamper-evident features. The packaging structure has an outer structure joined in face-to-face relation to an inner structure by an adhesive layer. The outer structure has at least one layer of flexible material and the inner structure also has at least one layer of flexible material. An outer line of weakness is formed in the outer structure. The outer line of weakness delineates an outer opening portion that is at least partially separable from the outer structure along the outer line of weakness. An inner line of weakness is formed in the inner structure inwardly of the outer line of weakness. The inner line of weakness delineates a removable inner portion that is separable from the inner structure along the inner line of weakness. A vacancy in the adhesive layer between the inner and outer structures is defined contiguous with the removable inner portion, such that the removable inner portion remains in place when the adjacent outer opening portion is separated from the outer portion. The region of the adhesive layer located laterally between the inner and outer lines of weakness comprises a pressure-sensitive adhesive. The outer opening portion is resealable to the inner portion after opening by means of the pressure-sensitive adhesive in the lateral portion.

Further features and advantages of the present invention will become apparent by a review of the description below.

### BRIEF DESCRIPTION OF THE DRAWINGS

For the purpose of illustrating the invention, the drawings show forms that are presently preferred. It should be understood that the invention is not limited to the precise arrangement and instrumentality shown in the drawings.

FIG. 1 is a perspective view of a first embodiment of a package having a reclosable, tamper-evident opening, shown in a closed position with adhesive regions in phantom:

FIG. 2 is a perspective view of the package of FIG. 1, shown in a partially open position.

FIG. 3 is a cross-sectional view of a first embodiment of a laminate used to construct the package shown in FIG. 1 taken along the line 3-3.

FIG. 4 is a cross-sectional view of the laminate of FIG. 3, with the opening shown in an open position.

FIG. 5 is a cross-sectional view of a second embodiment of a laminate used to construct the package shown in FIG. 1 taken along the line 3-3.

FIG. 6 is a cross-sectional view of the laminate of FIG. 5, with the opening shown in an open position.

### DETAILED DESCRIPTION

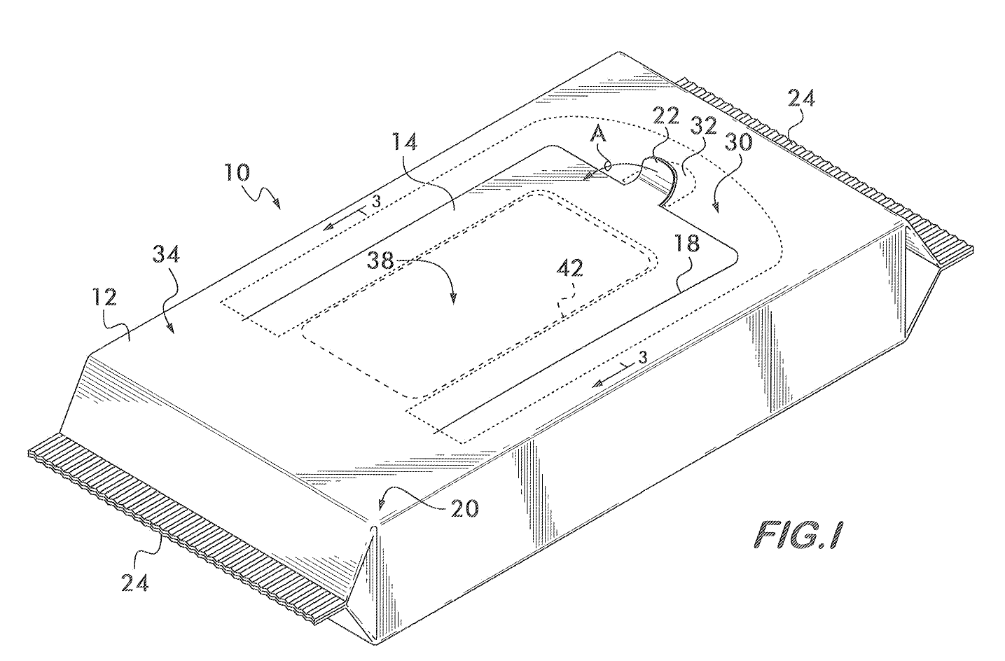

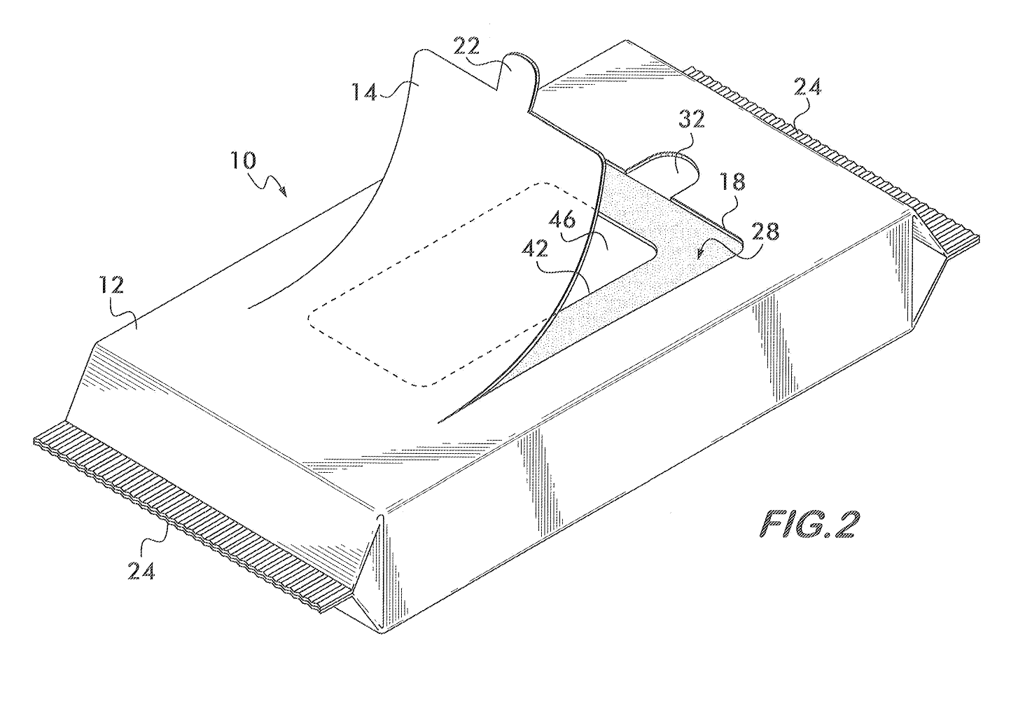

Referring to the figures, like numerals are used to indicate like elements throughout. FIGS. 1-6 show an embodiment of a flexible package. The package is indicated by the reference numeral 10. The package 10 is shown as having a generally rectangular construction, but may have any desired shape. The package 10 includes a top face 12 with a reclosable flap 14. FIG. 2 shows the package 10 with the flap 14 in a partially open position.

The package 10 may be formed from a single sheet of laminate material 16 that is folded to form the interior volume and sealed at each longitudinal end 24 and along a longitudinal seam (not shown) extending between each longitudinal end 24, using adhesive, heat sealing or other known methods. On the outer surface of the top face 12, the flap 14 is defined by a first die cut or similar line of weakness 18 that extends through a first layer or outer structure 20 of the laminate material 16. The first die cut 18 has a generally U-shaped profile, with a smaller U-shaped tab 22 located at the closed, or bottom end, of the U-shape defining the flap 14.

Referring now to FIGS. 1-4, the first layer 20 defines the outer surface of the package 10. The first layer 20 may comprise multiple layers laminated to each other or may be a single layer of material. The first layer 20 may be constructed using a polyester material. Affixed to the first layer 20, via an adhesive layer 26 is a second layer or inner structure 44.

An adhesive layer 26 is located immediately adjacent the first layer 20, towards the interior of the package 10. The adhesive layer 26 may be pattern applied using multiple types of adhesive located throughout. A layer of pressure-sensitive adhesive 28 is located in a first region 30 adjacent the first die cut 18. The pressure-sensitive adhesive region 30 preferably covers a portion of the area laterally inward of the first die cut 18. A first vacancy 32 (FIG. 1) is provided in the pressure-sensitive adhesive layer 28 proximate the tab 22, to facilitate lifting of the tab 22 in direction A away from the package surface, to begin peeling back the flap 14.

A second region 34 of the adhesive layer 26 comprises permanent adhesive 36 and is located outside of the first region 30 and preferably is located throughout the remainder of the laminate material 16 used to construct the package 10. As seen best in FIG. 1, the second region 34 covers the majority of the surface area of the package 10. A second vacancy 38 is provided within the adhesive layer 26 inward of the first region 30 in the central area of the flap 14. The second vacancy 38 is preferably aligned with an opening in the package 10, as will be described in further detail below.

The second layer 44 may be a single layer of material, such as oriented polypropylene, or a combination of multiple materials. The second layer 44 defines the inner surface of the package 10. A second die cut or line of weakness 42 extends at least partially through the second layer 44. The second die cut 42 is offset from and located laterally inward from the first die cut 18. As shown, the second die cut 42 has a generally rectangular profile. However, the profile of the die cuts 18, 42 may vary as desired to suit the intended purpose of the package 10. The die cuts 18, 42 may be a partial die cut, a score line, a laser cut, a serration, a perforation pattern or the like and creates a line of weakness in the associated layer that facilitates separation of the portions on opposite sides of the line. The second die cut 42 defines a removable inner panel 46 formed from the material of the second layer 44. The removable panel 46 is preferably smaller than the flap 14 and covered by the flap 14 when the flap 14 is in a closed position.

Referring now to FIG. 2, a portion of the pressure-sensitive adhesive 28 is exposed between the first die cut 18 and second die cut 42, when the flap 14 is lifted. The removable panel 46 within the second layer 44 lies laterally inward of the pressure-sensitive adhesive 28 and the second die cut 42. The removable panel 46 initially remains connected to the remainder of the second layer 44 when the flap 14 is lifted. The removable panel 46 does not adhere to the flap 14 as the result of the second vacancy 40 within the adhesive layer 26.

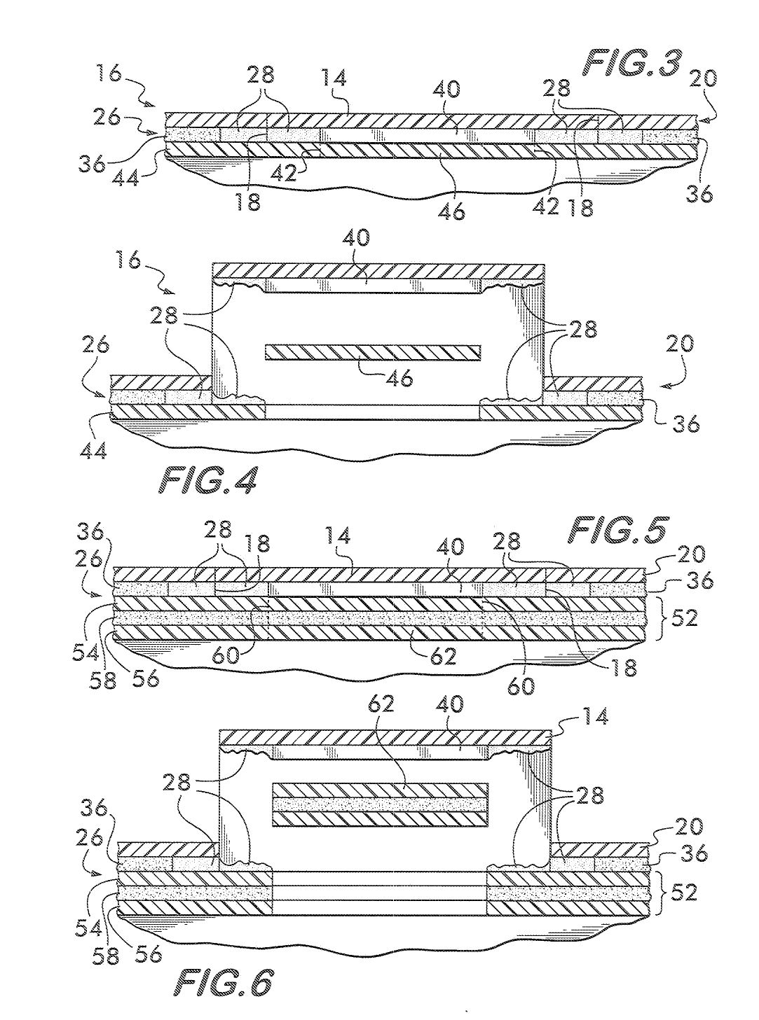

FIG. 3 shows a portion of the laminate material 16 in cross-section, as taken along the line 3-3 of FIG. 1, with the flap 14 in the closed position. The first die cut 18 extends through the first layer 20 to the pressure-sensitive adhesive 28. The vacancy 40 is located between the flap 14 and the removable panel 46. The vacancy 40 may be void of adhesives or, alternatively, may include a relatively weaker adhesive or a blocking material that resists strong adherence of the bottom surface of the flap 14 to the upper surface of the removable panel 46.

FIG. 4 shows the laminate material 16 with the flap 14 in the open position and the removable panel 46 separated from the remainder of the second layer 44. The removable panel 46 is separated from the inner layer 44 along the second die cut 42 by tearing along the line. When the flap 14 is peeled open, at least a portion of the pressure-sensitive adhesive 28 remains on the upper side of the second layer 44 exposed in the area laterally between the first cut line 18 and the second cut line 42. One of the first or second layers 20, 44 may be treated to reduce the affinity of the pressure-sensitive adhesive with the surface of the material, thereby causing the pressure-sensitive adhesive 28 to remain on only one of the exposed surfaces.

FIGS. 5 and 6 show a second embodiment of a laminate material 50. The laminate has the same first layer or outer structure 20, similar to the material 16 discussed above. Also, the adhesive layer 26 of the laminate material 50 is contemplated to be the same as the adhesive layer discussed above.

The laminate material 50 has a second layer or inner structure 52 constructed of first and second inner portions 54, 56 that are adhered to each other with an inner adhesive 58. The inner adhesive 58 preferably comprises a permanent adhesive, although other forms of attachment are possible. The first inner structure portion 54 may be made of oriented polypropylene or some other material that facilitates adherence to both the second inner portion 56 and the outer structure 20 via the respective adhesive layers 26, 58. The second inner layer 56 is preferably a sealant layer, such as a polyethylene.

An inner die cut or weakened line 60 extends through the inner layer 52. The weakened line 60 may be a partial die cut, a score line, a serration, a laser cut, a perforation pattern or any other weakness that will facilitate removal of the removable inner portion 62. The weakened line 60 defines an inner portion 62 that may be removed after the flap 14 is peeled back, similar to removing the removable panel 46 discussed above.

The package 10 made of laminate materials 16 or 50 provides a reclosable, tamper-evident enclosure. The reclosable feature is provided by the pressure-sensitive adhesive 28 located in the area laterally inward of the first die cut line 18. This type of adhesive allows a user to relatively easily open the flap 14 and then to reseal the flap. Evidence of tampering is provided by the removable panel 46 or inner portion 62. Once the flap is opened and the removable panel 46 or inner portion 62 have been (fully or partially) separated from the remainder of the inner structure 44, 52, there is an indication that the package has been previously opened. The removable panel 46 or removable inner portion 62 cannot be replaced or adhered to the flap 14, due to the vacancy 40 in the adhesive layer 26.

The pressure-sensitive adhesive 28 may be one of any known compositions. Pressure-sensitive adhesives form viscoelastic bonds that are aggressively and permanently tacky, adhere without the need of more than a finger or hand pressure, and require no activation by water, solvent or heat. Pressure-sensitive adhesives are often based on non-crosslinked rubber adhesives in a latex emulsion or solvent-borne form, or can comprise acrylic and methacrylate adhesives, styrene copolymers (SIS/SBS) and silicones. Acrylic adhesives are known for excellent environmental resistance and fast-setting time when compared with other resin systems. Acrylic pressure-sensitive adhesives often use an acrylate system. Natural rubber, synthetic rubber or elastomer sealants and adhesives can be based on a variety of systems, such as silicone, polyurethane, chloroprene, butyl, polybutadiene, isoprene, or neoprene.

When the contemplated package is to be used for food packaging, the pressure-sensitive adhesive must be a food-grade composition if potentially in the area of food contact. Various pressure-sensitive adhesives are approved by the US Food and Drug Administration, as regulated by 21 CFR Part 175.300. A preferred food-grade pressure-sensitive adhesive for use in the present invention is Jonbond 743, available from Bostik Findley. Additives (e.g., particulates or the like) can be included in the pressure-sensitive adhesive to reduce the tenacity of the bond to either of the first or second layers, if desired, so that the pressure-sensitive adhesive readily detaches from one of the first or second layers on opening of the flap.

The permanent adhesive may be of any known composition. A suitable example includes two-component polyurethane adhesive systems, such as Tycel 7900/7283 available from Henkel.

Polyester is mentioned as the preferred material of the first and second layers and the inner and outer structures. Various materials can be used within the first and second layers and the inner and outer structures, including polyesters, polyolefins (including homopolymers and copolymers), polyamides, paper, metal foil and the like.

In addition, the second layer or inner structure may include a barrier layer (not shown) including barrier polymer films, such as ethylene vinyl alcohol copolymer (EVOH), polyamide and the like. A barrier layer may also include metallized polyolefin films, such as polyethylene, polypropylene, oriented polypropylene and the like; AlOx-coated polymer films; SiOx-coated polymer films; metal foil; etc.

Although the invention has been described and illustrated with respect to the exemplary embodiments thereof, it should be understood by those skilled in the art that the foregoing and various other changes, omissions and additions may be made therein and thereto, without parting from the spirit and scope of the present invention. Accordingly, reference should be made to the appended claims, rather than to the foregoing specification, as indicating the scope of the invention.

1. A laminate material for packaging, comprising:
a first layer having a first weakened line therethrough, said weakened line defining a first flap;
a second layer adhered to the first layer, the second layer having a second weakened line formed therein and positioned inwardly of the first weakened line, said second weakened line defining a removable panel within the second layer; and
an adhesive layer located between the first and second layers, the adhesive layer having pressure-sensitive adhesive in a region located inwardly of the first weakened line in the first layer and outwardly of the second weakened line in the second layer, and an adhesive vacancy located laterally inward of the pressure-sensitive adhesive and between the removable panel and the first flap, such that the removable panel remains connected to the second weakened layer when the first flap is peeled back along the first weakened line.

2. The laminate material according to claim 1, wherein the first weakened line is a partial die cut.

3. The laminate material according to claim 1, wherein the adhesive layer further comprises permanent adhesive between the first and second layers in areas other than the vacancy and the pressure-sensitive adhesive region.

4. The laminate material according to claim 1, wherein the first weakened line is generally U-shaped, and the first flap is generally rectangular with one side of the first flap remaining connected to the remainder of the first layer.

5. The laminate material according to claim 1, wherein the first layer comprises polyester.

6. The laminate material according to claim 1, wherein the second layer comprises a sealant layer.

7. A flexible packaging structure having built-in reclose and tamper-evident features, comprising:
an outer structure joined in face-to-face relation to an inner structure by an adhesive layer, the outer structure comprising at least one layer of flexible material and the inner structure comprising at least one layer of flexible material;
an outer line of weakness formed in the outer structure, the outer line of weakness delineating an outer opening portion that is separable from the outer structure along the outer line of weakness; and
an inner line of weakness formed in the inner structure and positioned inwardly of the outer line of weakness, the inner line of weakness delineating a removable inner portion that is separable from the inner structure along the inner line of weakness and that is covered by the outer opening portion,
wherein the removable inner portion is separable from the outer opening portion, such that the removable inner portion remains joined to the inner structure when the outer opening portion is removed from the remainder of the outer portion, and
wherein the region of the adhesive layer located laterally between the inner and outer lines of weakness comprises pressure-sensitive adhesive and the outer opening portion is resealable to the inner portion after opening by means of the pressure-sensitive adhesive in the lateral area.

8. The flexible packaging structure of claim 7, wherein one of the outer and inner structures has a greater affinity for bonding to the pressure-sensitive adhesive than does the other of the outer and inner structures such that the pressure-sensitive adhesive remains with one of the outer and inner structures.

9. The flexible packaging structure of claim 7, wherein the outer line of weakness is generally U-shaped and defines an outer opening portion that is connected to the remainder of the outer structure at one end.

10. The flexible packaging structure of claim 7, wherein the outer structure includes a layer that is reverse-printed on a surface of the layer facing the inner structure.

11. The flexible packaging structure of claim 7, wherein the inner structure includes a layer of heat-sealable material forming an inner surface.

12. The flexible packaging structure of claim 7, wherein the inner structure includes a barrier layer providing a barrier against passage of at least one of moisture and oxygen.

13. The flexible packaging structure of claim 12, wherein the barrier layer comprises a polymer film having a coating of vapor-deposited metal.

14. The flexible packaging structure of claim 7, wherein the outer structure comprises a layer of polyethylene terephthalate.

15. The flexible packaging structure of claim 14, wherein the inner structure comprises a multi-layer web comprising a metallized film and a sealant layer.

16. The flexible packaging structure of claim 15, wherein the metallized film comprises metallized oriented polypropylene.

17. A package for products, comprising:
a flexible packaging laminate material comprising an outer structure laminated to an inner structure using an adhesive layer, the outer structure forming an outer surface of the package and comprising at least one layer of flexible material, the inner structure comprising at least a flexible barrier layer facing the outer structure and a polymer sealant layer forming an inner surface of the package; and
a tamper-evident reclose feature formed in the laminate, and comprising an outer flap portion formed by a generally U-shaped line of weakness in the outer structure, and an inner removable portion formed from the inner structure by scoring the inner structure along a generally rectangular inner score line, the inner score line defining an opening into the container when the outer flap portion is peeled back and the inner removable portion is removed,
wherein the region of the adhesive layer located laterally between the inner and outer score lines comprises pressure-sensitive adhesive and the outer opening portion is resealable to the inner portion after opening, and
wherein the adhesive layer comprises a vacancy between the inner removable portion and the outer flap, such that the inner removable portion remains attached to the remainder of the inner structure when the outer flap is peeled back.

18. The flexible packaging structure of claim 17, wherein the inner score line is a die cut perforation line.
